(19) United States
(12) Patent Application Publication
(10) Pub. No.: US 2007/0091322 A1
(43) Pub. Date: Apr. 26, 2007

(54) Optical information verifying device

(75) Inventor: Atsushi Tano, Kariya-shi (JP)

Correspondence Address: POSZ LAW GROUP, PLC, 12040 SOUTH LAKES DRIVE, SUITE 101, RESTON, VA, 20191, US

(73) Assignee: DENSO WAVE INCORPORATED, Tokyo (JP)

(21) Appl. No.: 11/585,116

(22) Filed: Oct. 24, 2006

(30) Foreign Application Priority Data
Oct. 26, 2005 (JP) 2005-311265

(51) Int. Cl. G01B 11/24

(52) U.S. Cl. 356/610

(57) ABSTRACT

The optical information verification apparatus includes an image pickup section picking up an image of optical information recorded on a display medium, a measuring section measuring a record state of optical information picked up by the image pickup device in terms of a given evaluation item and outputting a measured value of the record state, a comparing section comparing the measured value output from the measuring section with a given reference value, and outputting a comparison result, and an improving point outputting section converting the comparison result output from the comparing section into an improving point associated with the comparison result, and outputting the improving point.

### CROSS-REFERENCE TO RELATED APPLICATION

This application is related to Japanese Patent Application No. 2005-311265 filed on Oct. 26, 2005, the contents of which are hereby incorporated by reference.

### BACKGROUND OF THE INVENTION

1. Technical Field of the Invention

The present invention relates to an optical information verifying device configured to measure record condition of optical information recorded or printed on display media in terms of given evaluation items, compare a measured value with a given reference value, and evaluate the record condition of the optical information on the basis of the comparison result.

2. Description of the Related Art

Optical information, such as bar codes and two-dimensional codes printed on display media such as product labels or films attached onto industrial products or the like have been used for distribution managements. Currently, however, optical information is being used in advertisements on newspapers or magazines and the like. For instance, optical information is often used as information medium to direct a consumer to a homepage on an Internet that is managed by an advertiser such as an enterprise who places the advertisement.

Such optical information is mainly printed on display medium such as a paper sheet or a polyethylene film or the like. Even if optical information is printed correctly in a designated print dimension and with a designated reflection ratio, the printing results vary due to printing condition variation. In addition, deterioration takes place on the printing quality depending on environmental change after a product has arrived on the market.

Such deterioration in the printing quality of optical information not only affects management of products attached with the optical information, but also causes a problem that when the optical information is used as information medium to direct a consumer to a relevant homepage as mentioned above, the consumer cannot reach the homepage, and in addition, a corporate image of the advertiser may be harmed due to unreadable information on the products.

To address such a problem, research and development work has heretofore been made to provide a two-dimensional code verifying device as a device for verifying print quality of such optical information as disclosed in Japanese Unexamined Patent Application Publication No. 9-128469. The two-dimensional code verifying device comprises readout means reading out an image of a two-dimensional code printed on print medium (display medium), reference item setting means for setting reference items for the two-dimensional code image, read out by the readout means, to be evaluated, evaluating means sequentially evaluating the two-dimensional code image on the basis of the reference items set by the reference item setting means, and verifying means verifying whether a print condition of the two-dimensional code on print medium is right or wrong on the basis of the evaluation result of the evaluating means. Thus, the print condition can be evaluated in terms of the evaluation items to achieve comprehensive evaluation on the basis of the resulting evaluation result, making it possible to accurately and precisely verify whether or not the two-dimensional code is properly printed.

However, with the two-dimensional code verifying device disclosed in the above Patent Document, although it is possible to verify the printed condition of the two-dimensional code, the output evaluation result remains to an extent wherein an evaluated numeric value quantified in terms of the reference items to be verified is calculated, and comprehensive judgment is made on the basis of such a numeric value to determine whether the printed quality is good or bad. That is, judgment is made to determine merely whether or not printed optical information is properly printed. Accordingly, when an evaluation result indicates that printed condition is not good, it does not show any definite solution on which part of the two-dimensional code printed should be corrected, and which points should be improved to enable optical information to be properly printed.

Generally, to accurately extract the points to be improved (may be referred to as “improving points” hereinafter), it is necessary to ask an expert or an experienced engineer to analyze the evaluation result, and to provide advice on the way to improve the printing quality of the optical information. However, this requires high cost and time consuming process.

In a case where no such advice from the expert or engineer is available, printing must be repeatedly carried out by trial and error under various conditions including selecting ink or toner, and printing medium such as a paper sheet or a film, setting a label printer, and changing models of printers. Therefore, also in this case, considerable increase in cost and time is unavoidable to correctly extract the improving points.

### SUMMARY OF THE INVENTION

The present invention provides an optical information verification apparatus comprising:

an image pickup section picking up an image of optical information recorded on a display medium;

a measuring section measuring a record state of the optical information picked up by the image pickup section in terms of a given evaluation item and outputting a measured value of the record state;

a comparing section comparing the measured value output from the measuring section with a given reference value, and outputting a comparison result; and

an improving point outputting section converting the comparison result output from the comparing section into an improving point associated with the comparison result, and outputting the improving point.

According to the present invention, when a record state of the optical information is detected to be improper, an improving point indicating in which respect and in what way the recorded optical information should be corrected is provided. This makes it possible to record quite readily the optical information in high quality without asking advice from an expert.

The optical information verification apparatus may further comprise a record condition inputting section for inputting a record condition of the optical information affecting the record condition of the optical information, wherein the improving point outputting section converts the comparison result into the improving point depending on the record condition input by the record condition inputting section.

The optical information verification apparatus may further comprise a readout condition inputting section for inputting a readout condition of the optical information affecting the record condition of the optical information,

wherein the improving point outputting section converts the comparison result into the improving point depending on the readout condition input by the readout condition inputting section.

The optical information verification apparatus may further comprise a type information inputting section for inputting a type of the optical information affecting the record condition of the optical information, wherein the improving point outputting section converts the comparison result into the improving point depending on the type input by the type information inputting section.

The optical information verification apparatus may further comprise:

an inputting section for inputting at least one of a record condition of the optical information affecting the record condition of the optical information, a readout condition of the optical information affecting the record condition of the optical information, and a type of the optical information affecting the record condition of the optical information; and

an improving point conversion table operative to retrieve therefrom the improving point depending on at least one of the record condition, the readout condition and the type input by the inputting section, and the comparison result output from the comparing section.

The optical information verification apparatus may be portable, and may further comprise:

a readout port to which a reflected light beam reflected from the optical information can be incident; and

a guide member mounted to the readout port so as to extend outwardly to enable a distance between the readout port and the optical information to be kept at a predetermined value.

The optical information verification apparatus may be portable and may further comprise:

an illuminating section operative to irradiate an illumination light beam onto the optical information;

a readout port operative to take in a reflected light beam resulting from the illumination light beam reflected by the optical information; and

a light interception member mounted to an opening periphery of the readout port so as to allow the illumination light beam and the reflected light beam to pass therethrough, while blocking external light other than the illumination light beam and the reflected light beam.

The illuminating section may be configured to irradiate an illumination light beam having substantially the same emission property as an illumination light beam which an optical information readout apparatus irradiates onto the optical information to read out the optical information.

The illumination light beam may have three primary color components or a white color component, and emission intensity and conditions to turn on and off may be independently set for each color component.

The improving point outputting section may be operative to output the improving point through at least one of display means capable of displaying at least one of character information, mark information and figure information, and an outputting means capable of outputting at least one of a voice and a sound.

Other advantages and features of the invention will become apparent from the following description including the drawings and claims.

### BRIEF DESCRIPTION OF THE DRAWINGS

In the accompanying drawings:

FIG. 1 is a longitudinal sectional view in a typical form showing a structure of a two-dimensional code verifying device of an embodiment according to the present invention;

FIG. 2 is a block diagram showing a circuit structure of the two-dimensional code verifying device of the present embodiment;

FIGS. 3A to 3C are typical illustrative views showing various alternative examples of the two-dimensional code verifying device of the present embodiment, with FIG. 3A showing an example provided with a readout guide, FIG. 3B showing another example provided with a light shading hood and FIG. 3C showing still another example provided with a mirror hood;

FIG. 4 is an illustrative view showing a structural outline of a QR code acting as one example of a two-dimensional code;

FIG. 5 is a flow chart showing a flow of verifying operation to be executed by the two-dimensional code verifying device of the present embodiment;

FIGS. 6A to 6C are illustrative views showing examples of setting offset distances using a marker light beam irradiated from the two-dimensional code verifying device of the present embodiment, with FIG. 6A showing an example in which the offset distance is set to a proper distance, FIG. 6B showing another example in which the offset distance is set to an improper distance in a short length from the proper distance, and FIG. 6C showing another example in which the offset distance is set to another improper distance in a remote length from the proper distance;

FIG. 7A is an illustrative view showing one example of image information obtained by a light-receiving sensor;

FIG. 7B is an illustrative view showing one example of image information subsequent to image information, shown in FIG. 7A, being subjected to binary coding processing;

FIG. 7C is an illustrative view showing an example of image information of an area segmented in pixel units encircled by a dotted line;

FIG. 8 is an illustrative view showing one example of an evaluated value conversion table incorporated in the two-dimensional code verifying device of the present embodiment;

FIG. 9 is an illustrative view showing one example of a message table incorporated in the two-dimensional code verifying device of the present embodiment; and

FIGS. 10A and 10B are diagrams showing display examples of evaluation results output to a liquid crystal display unit of the two-dimensional code verifying device of the present embodiment, with FIG. 10A showing a case in a favorable result and FIG. 10B showing a case in an unfavorable result.

### DETAILED DESCRIPTION OF PREFERRED EMBODIMENTS

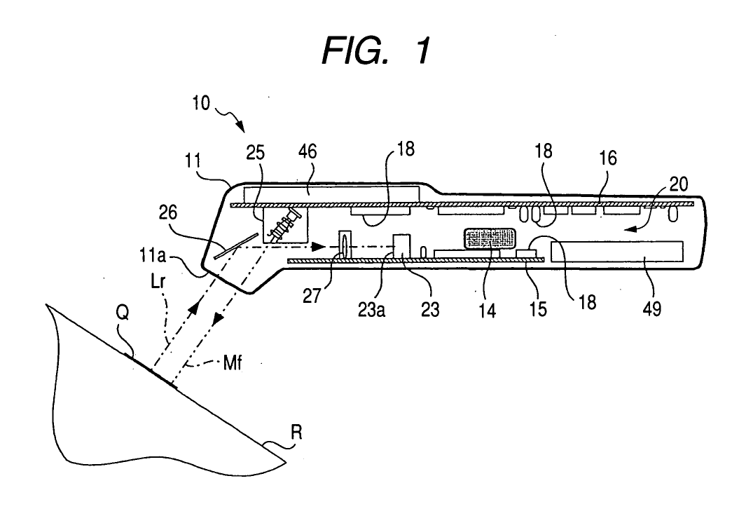

Hereunder, an optical information verification device of an embodiment according to the present invention is described below in detail with reference to the accompanying drawings. First, a two-dimensional code verifier 10 of the present embodiment is described with reference to FIGS. 1 to 3.

As shown in FIG. 1, the two-dimensional code verifier 10 mainly comprises an elongated housing 11 formed in a substantially rectangular box-like configuration, a circuit section 20 accommodated inside the housing 11, and a battery 49 received in the housing 11 to supply driving electric power to the circuit section 20.

The housing 11, made of, for instance, a molded component part formed of synthetic resin such as ABS resin, has one end formed with a readout port 11a with a “bent neck shape” leaning forward toward a backside direction of the housing 11. The readout port 11a has an opening portion, available to guide an incident light beam to a light-receiving sensor 23 of the circuit section 20 that will be described later, and a structure to which a readout guide 50 or a shading hood 60 is mounted in a manner as described below. Meanwhile, the housing 11 has the other end formed with a battery box (not shown) available to accommodate the battery 49. In addition, the housing 11 has a front face formed with an opening portion available for a liquid crystal display unit 46 to be mounted and is structured for an operator of the two-dimensional verifier 10 to visually get a display content of a display on a liquid crystal display unit 46.

The circuit section 20 comprises a variety of electronic component parts 18, etc., that are mounted on printed circuit boards 15, 16 internally accommodated in the housing 11. That is, the circuit section 20 comprises an optical system including an illumination light sources 21, the light-receiving sensor 23, an imaging lens 27, etc., a microcomputer system (hereinafter referred to as microcomputer) such as a memory 35, a control circuit 40, an operation switch 42, the liquid crystal display unit 46, etc., and a power supply system such as a power switch 41, the battery, etc. These component parts are mounted on the printed circuit boards 15, 16 or internally accommodated in the housing 11.

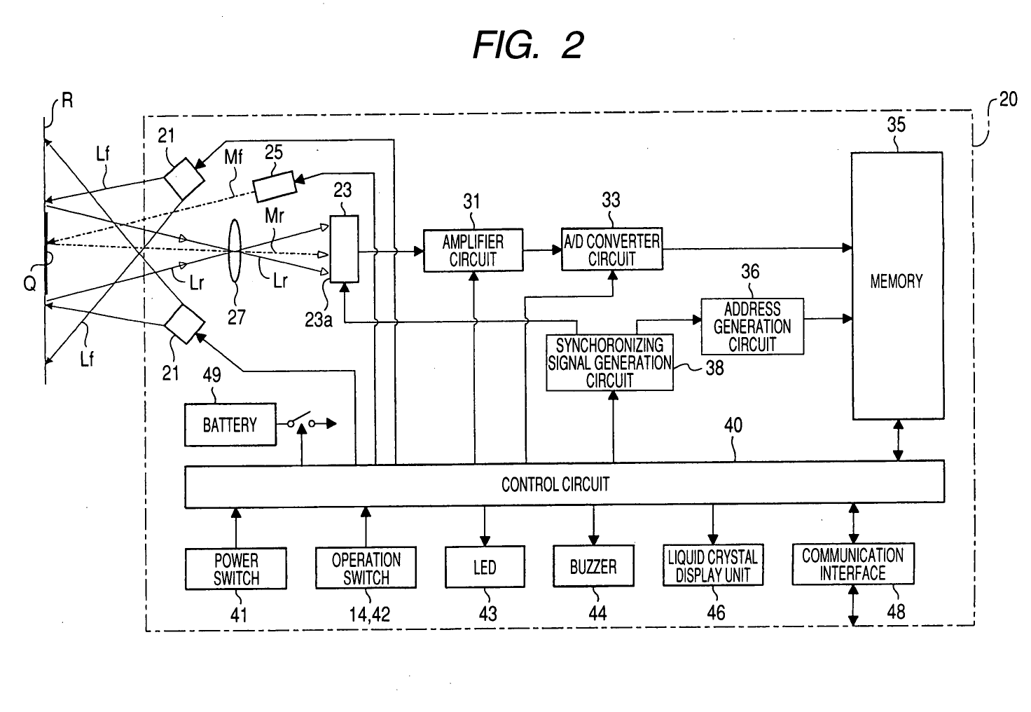

Now, a structure of the circuit section 20 is described with reference to FIG. 2. As shown in FIG. 2, the optical system, forming the circuit section 20, comprises the illumination light sources 21, the light-receiving sensor 23, a marker light source 25, the imaging lens 27, etc. Although the illumination light sources 21 are not described in FIG. 1, the illumination light sources 21 may comprise those such as, for instance, a red LED, a diffusion lens, a collective lens, etc., which act as illumination light sources available to emit illumination light beams. In the present embodiment, the illumination light sources 21 are located on both sides of the light-receiving sensor 23 in front thereof and structured to be capable of irradiating illumination light beams Lf to a reading object R via the readout port 11a of the housing 11.

Although the red LED is used in the present embodiment, any emission color, for example, a blue color, a white color, etc., may be used to conform to the emission color of a light beam of a two-dimensional bar code reader (optical information readout device) that can read out the two-dimensional code Q. With such configuration, the illumination light sources 21 can irradiate the illumination light beams Lf under the conditions closer to the conditions under which the illumination light beam of the two-dimensional bar code reader is irradiated.

The light-receiving sensor 23 is structured to be capable of receiving reflection light beams Lr irradiated to or reflected from the reading object and the two-dimensional code Q and corresponds to an area sensor composed of light receiving elements such as, for instance, a C-MOS, a CCD, etc., arrayed in two-dimension in the order of one million pieces. A light-receiving sensor unit 23a of the light-receiving sensor 23 takes the form of a structure to be visible from an area outside the housing 11 via the readout port 11a, and the light-receiving sensor 23 is mounted on the printed circuit board 15 to allow the light-receiving sensor unit 23a to receive the incident lights incoming through the imaging lens 27.

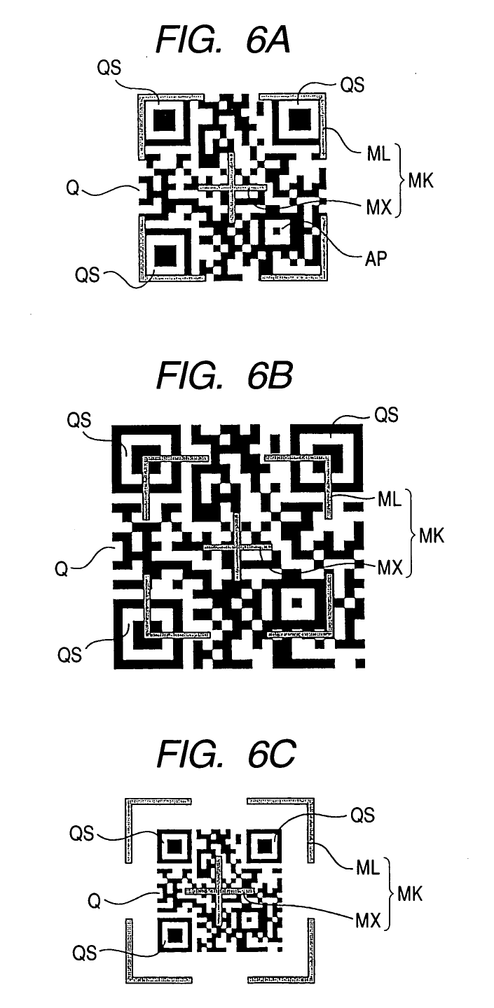

The marker light source 25, acting as a marker light source that is capable of emitting a marker light beam Mf to provide a user of the two-dimensional verifier 10 with notification of an appropriate readout position, is structured with, for instance, a laser diode, a diffusion lens, a collective lens, etc, a slit disc available to be formed with a pattern such as a center mark MX based on the marker light beam Mf and a corner marks ML, an imaging lens and an aperture disc all of which are placed on a light emitting side of the laser diode. With such a structure, as the marker light beam Mf is irradiated onto a reading object R, a surface of the reading object R is displayed with a marker MX resulting from the corner marks ML and the center mark MX as shown in FIG. 6A. Thus, adjusting a position so as to allow the corner marks ML and an outside of the two-dimensional code Q to match each other with a center on the center mark MX makes it possible to maintain a distance between the reading object R and the readout port 11a in a fixed value.

The imaging lens 27, capable of functioning as an imaging optical system available to form an image on the light-receiving sensor unit 23a of the light-receiving sensor 23 upon focusing incident light beams incoming through the housing 11 from an outside, is structured of, for instance, a lens barrel and a plurality of collective lenses accommodated in the lens barrel. In addition, though not shown in FIG. 2, a reflection mirror 26 is disposed in the readout port 11a for altering a light path of the reflection light beam Lr incoming through the readout port 11a upon reflecting at the two-dimensional code Q as shown in FIG. 1.

Next, a structural outline of the microcomputer system is described. As shown in FIG. 2, the microcomputer system comprises an amplifier circuit 31, an A/D converter circuit 33, a memory 35, an address generation circuit 36, a synchronizing signal generation circuit 38, a control circuit 40, an operation switch 42, an LED 43, a buzzer 44, a liquid crystal display unit 46, a communication interface 48, etc. The microcomputer system mainly comprises the control circuit 40, capable of acting as, as implied by the name, a microcomputer (information processing unit), and the memory 35 and operates so as to process an image signal on the two-dimensional code Q picked up by the optical system mentioned above in hardware or software. Moreover, the control circuit 40 also performs controls related to an overall system of the two-dimensional code verifier 10.

The image signal output from the light-receiving sensor 23 of the optical system is input to the amplifier circuit 31 and amplified with a given gain, after which the image signal is applied to the A/D conversion circuit 33 for conversion from an analog signal to a digital signal. The digitized image signal, that is, image data is then input to the memory 35 for storage in a given input buffer. In addition, the address generation circuit 36 is structured to generate a storage address of image data stored in the memory 35 in response to a synchronizing signal applied from the synchronizing signal generation circuit 38.

The memory 35 includes a semiconductor memory device that comprises, for instance, a reading object RAM (DRAM, SRAM, etc.) and a reading object ROM (EPROM, EEPROM, etc.). Of this memory 35, the RAM comprises the given buffer areas and work areas for the control circuit 40 to execute arithmetic operations and logical operations. Moreover, the ROM preliminarily stores, in addition to given programs for enabling verification processing, which will be described below, system programs operative to control various hardware such as the illumination light sources 21, the light-receiving sensor 23, the marker light source 25, etc.

The control circuit 40 includes the microcomputer operative to control a whole of the two-dimensional verifier 10, a CPU, a system bus and input and output interfaces and forms an information processing device together with the memory 35 to have an information processing function. The control circuit 40 has a structure to be connectable to various input and output devices (peripheral units) via incorporated input and output interfaces and with the present embodiment, is connected to the power switch 41, the operation switch 42, the LED switch 43, the buzzer 44, the liquid crystal display unit 46 and the communication interface 48. With such connection, the control circuit 40 can perform various operations including monitoring and managing the power switch 41 and the operation switch 42, turning on and turning off the LED 43 acting as an indicator and turning on, turning off the sounding of the buzzer 44 for generating a peep sound or an alarm sound and controlling an image of the liquid crystal display unit 46 for displaying a verified result of the readout two-dimensional code Q while making it possible to perform communication control of the communication interface 48 to execute serial communication with an external equipment. In addition, the operation switch 42 includes a trigger switch 14 providing commands to the illumination light sources 21 to irradiate the illumination light beams Lf.

The power supply system includes the power switch 41 and the battery 49 or the like and turning on or turning off the power switch 41, managed by the control circuit 40, allows the battery 49 to supply or interrupt the supply of a drive voltage to the various devices and various circuitries mentioned above. In addition, the battery 49 includes a secondary battery, such as a lithium ion battery or the like, which is available to generate a given DC current.

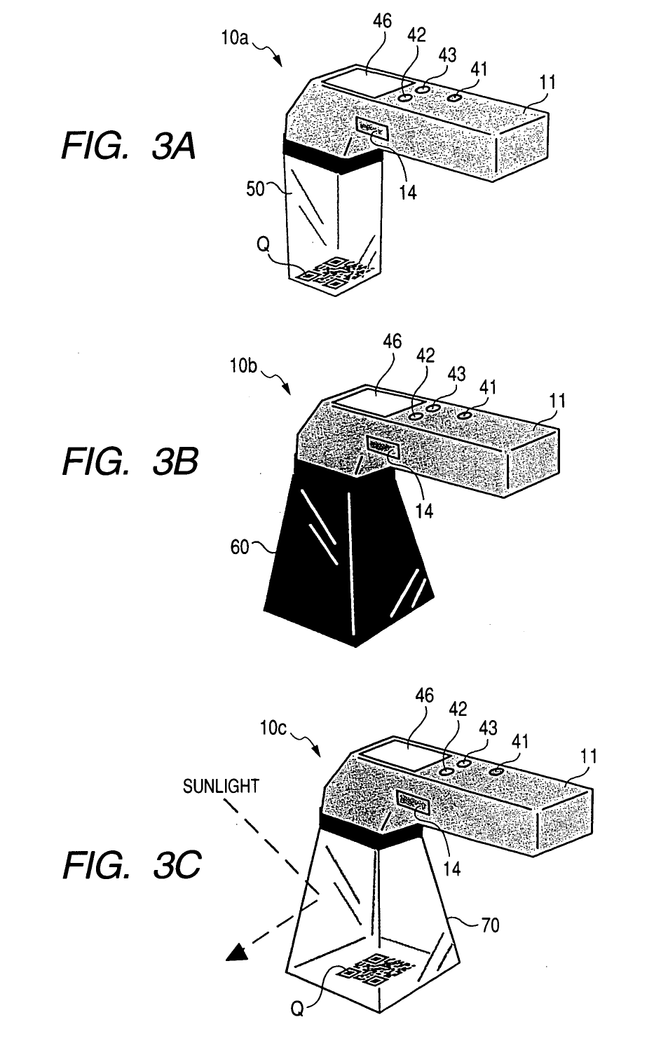

Next, description is made of an example of the readout guide 50 that can be mounted onto the readout port 11a of the housing 11 of the two-dimensional code verifier 10 formed in such a structure. As shown in FIG. 3A, for instance, with a two-dimensional code verifier 10a, the readout guide 50 in the form of a box-shaped tube is mounted on the readout port 11a. The readout guide 50, acting to keep a given offset distance between the two-dimensional code Q and the readout port 11a, is made of, for instance, transparent synthetic resin or the like. By so doing, the readout guide 50 enables the offset distance between the two-dimensional code Q and the readout port 11a to be kept at a fixed value with no need for the marker light source 25 to irradiate the marker light beam Mf in a manner as set forth above. Thus, no need arises to provide the marker light source 25 and the associated peripheral circuitries and the circuit section 20 can be formed in a simplified structure by that extent.

As shown in FIG. 3B, further, the shading hood in the form of a flared box-shaped tube may be mounted on the readout port 11a. The shading hood 60, acting to interrupt the transmission of light, may be made of synthetic resin with light blocking effect employed instead of material of the above-described readout guide 50. The two-dimensional code verifier 10, provided with such a shading hood 60, enables a distance between the two-dimensional code Q and the readout port 11a to be kept in a fixed value while interrupting the incoming of exogenous lights such as sunlight and another light incoming from an outside of the shading hood 60. Thus, covering the two-dimensional code Q with the shading hood 60 enables the exogenous lights from being irradiated onto the two-dimensional code Q. Therefore, if a need arises to verify the two-dimensional code Q with a precise contrast or if a need arises to prevent a drop in precision caused by adverse affects resulting from the exogenous lights, providing such a shading hood 60 enables the verification to be implemented even in a status with no, for instance, a dark room.

As shown in FIG. 3C, furthermore, a mirror hood 70 in the form of a flared box-shaped tube may be mounted on the readout port 11a. The mirror hood 70 is made of material like, for instance, a so-called magic mirror operative to reflect exogenous lights but transmit the internal illumination light beams Lf. The two-dimensional code verifier 10, provided with such a mirror hood 60, prevents the exogenous lights such as, for instance, sunlight from incoming to an inside of the mirror hood 70 while permitting the illumination light beams Lf irradiated inside the mirror hood 70 to transmit from the inside to the outside. Thus, such a mirror hood 70 is particularly effective in the two-dimensional code Q that has measuring items causing degraded precision even due to adverse affect resulting from the reflecting illumination light beams Lf in addition to adverse affect caused by the exogenous lights.

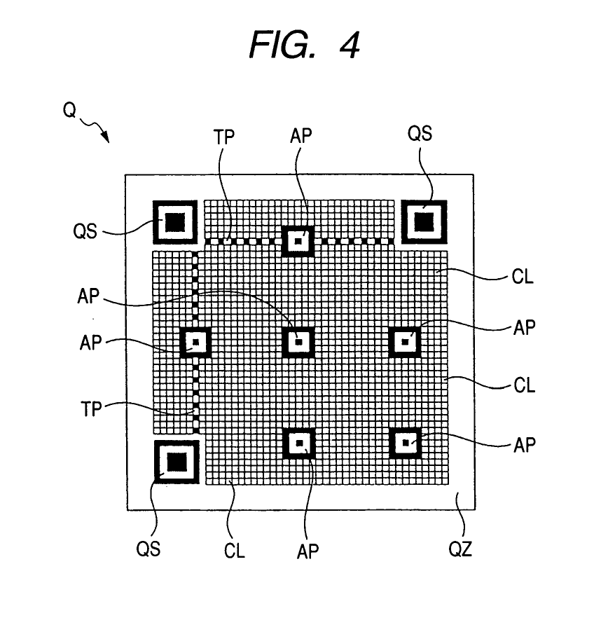

Now, a structural outline of a QR code is simply described as one example of the two-dimensional code Q with reference to FIG. 4. As shown in FIG. 4, the QR code comprises cells CL, opening symbols QS, alignment patterns AP, timing patterns TP and a quiet zone QZ. The cells CL include square shaped regions in black and white colors, arrayed in a square shaped matrix form like the grid of a go board, which represent minimal component elements of the QR code.

The opening symbols QS are composed of aggregates, including pluralities of cells placed in squared shapes at three corners of the matrix composed of the cells CL, and formed in structures enabling the detections of a location, a size and an inclination of the QR code. More particularly, the opening symbols QS include nine pieces of black cells CL disposed in a square shape with three cells x three cells, sixteen pieces of white cells CL surrounding such nine black cells, and twenty four black cells CL surrounding these white cells CL. The presence of such opening symbols QS makes it possible to achieve the detection of the QR code in 360 degrees.

The alignment patterns AP, composed of aggregates of pluralities of cells disposed in squared shapes for capability of correcting a distortion of the QR code, are placed in given areas within a squared area defined with the opening symbols QS at three locations. More particularly, the alignment pattern AP includes an independent black cell CL equivalent to one cell, eight pieces of white cells CL surrounding this black cell CL, and sixteen pieces of black cells CL surrounding the square shaped white cells CL, making it easy to detect a centered coordinates.

The timing patterns TP, composed of patterns each with repetition of white and black colors enabling timing extraction to be executed for obtaining the center coordinates of the respective cells CL, include the white cells CL and the black cells CL that are alternately disposed in straight lines. For instance, if the QR code is distorted or an error occurs in pitch of the cells CL, the timing patterns TP are used for correcting the center coordinates of the cells CL. The timing patterns TP are placed in longitudinal and lateral directions of the QR code, respectively, to run across the centers of given alignment patterns AP.

The quiet zone QZ is a spatial margin, disposed in an outside periphery out of a squared shape defined with the three opening symbols QS, which is set to lie in a width greater than a value of more than four cells CL oriented outward. The quiet zone QZ is made capable to detect a boundary of the QR code. In addition, in FIG. 4, among the matrixes in the squared shapes like the grids of the go board, an area excepting the above-described opening symbols QS, the alignment patterns AP and the timing patterns RP represents a data area that expresses binary data composed of, for instance, 1/0 codes in data in association with the white cells CL and the black cells CL.

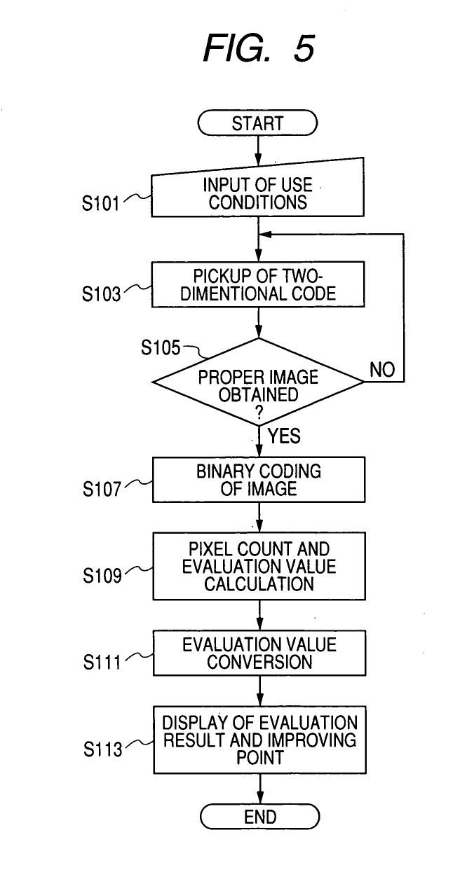

Next, an operational flow of evaluating operation to be executed by the two-dimensional code verifier 10 with such a structure is described with reference to FIG. 5. In addition, the control circuit 40 executes evaluation programs stored in the reading object ROM of the memory 35 described above for thereby carrying out the evaluating operation.

As shown in FIG. 5, in the evaluating operation, first, the operation in step S101 is executed to input use conditions. In such operation, the operator depresses the operation switch 42 and selects a given use condition according to a menu content displayed on the liquid crystal display unit 46, that is, a readout condition to determine whether the optical information readout device is a cell-phone or a two-dimensional code scanner.

As the use condition is input in step S101, two-dimensional code image picking up operation is executed in step S103. In this operation, for instance, the user depresses the trigger switch 14 to cause the illumination light sources 21 to irradiate the illumination light beams Lf onto the two-dimensional code Q and the reflected light beams Lr are incident through the readout port 11a onto the light-receiving sensor 23 to be exposed thereon for obtaining image information on the two-dimensional code Q. When this takes place, since the marker light source 25 irradiates the marker light beam Mf, the user of the two-dimensional code verifier 10 can keep an offset distance with respect to the two-dimensional code Q with landmark on the markers MK including the center mark MX and the corner marks ML specified by the marker light beam Mf.

In subsequent step S105, the operation is executed to judge whether or not an appropriate image is obtained. During such operation, as shown in FIGS. 6A to 6C, for instance, image recognition processing is executed to judge the positional relationship between the marker MK, specified by the marker light beam Mf, and the two-dimensional code Q. In particular, as shown in FIG. 6A, judgment is made to determine whether or not outer edges of the opening symbols (finder patterns) QS, provided at three corners of the two-dimensional code Q, match an outer edge of the corner marks ML of the marker MK.

If the both edges match each other as shown in FIG. 6A, a judgment is made that an appropriate image is obtained (with “YES” in S105) and the operation proceeds to subsequent step S107. In contrast, as shown in FIGS. 6B and 6C, if the outer edge of the opening symbols QS and the outer edge of the corner marks ML remain unmatched (with “NO” in S105), the operation goes to step S103 for repeated execution of two-dimensional code image pickup operation.

That is, as shown in FIG. 6B, under a circumstance where the corner marks ML get inside the two-dimensional code Q and parts of the opening symbols QS protrude to an area outside the corner marks ML, this represents that the two-dimensional code Q and the readout port 11a are two close to each other in offset distance. On the contrary, as shown in FIG. 6C, under a situation where there are blank space portions inside the corner marks ML and the opening symbols QS are present inside the blank space portions, this represents that the two-dimensional code Q and the readout port 11a are too far from each other in offset distance. With the present embodiment, thus, by irradiating the marker light beam Mf from the marker light source 25 to allow the associated corner marks ML and the center mark MX to be translated on the two-dimensional code Q, the user of the two-dimensional verifier 10 can be provided with the relationship on the offset distance between the two-dimensional code Q and the readout port 11a.

If judgment is made in operation in step S105 that the appropriate image is obtained (with “YES” in step S105), then, an image binary coding operation is executed from step S107. In executing this operation, the image signal, obtained by the light-receiving sensor 23, is stored in the memory 35 via the A/D conversion circuit 33 and, subsequently, a color component of a grey color intermediate between a black color and a white color is converted to black or white data according to a given threshold value. That is, this operation includes an operation in which a component except for black and while components in a grey scale is converted to black or white components.

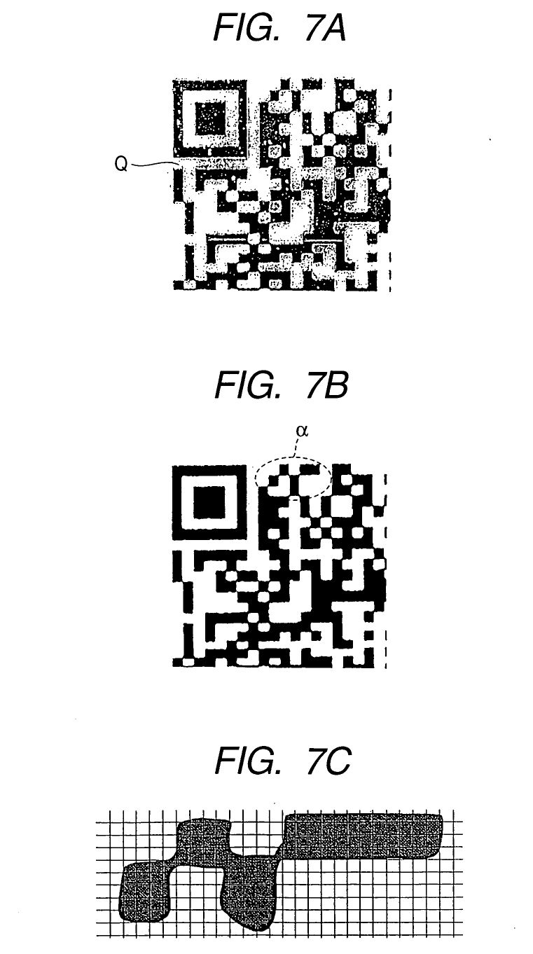

More particularly, since the image signal obtained by the light-receiving sensor 23 contains, in addition to the black and white components of the two-dimensional code Q, a grey component as shown in FIG. 7A, converting this grey component into black and white components results in conversion of binary values of black and white as show, for instant, in FIG. 7B. Here, expanding an area encircled with a broken-line ellipse results in image data as shown in FIG. 7C. That is, FIG. 7C shows pixels forming the light-receiving sensor 23 in grid form, representing black-and-white image information forming the two-dimensional code Q in association with the pixels. Therefore, measuring a width and length of a black minimal area (equivalent to the cell CL of the QR code) of the two-dimensional code Q in terms of pixel unit enables judgment to be made to determine whether or not the two-dimensional code Q is properly recorded (printed). During the operation of the present embodiment, such judgment processing is executed in step S109.

As the image binary coding operation in step S107 is finished as shown in FIG. 5, then, pixel counting and evaluated value calculating operation is executed in step S109. During such operation, the width and length of the minimal units (cells) forming the two-dimensional code Q in terms of the pixel unit is measured and the relevant measured result is calculated as an evaluated value as described above with reference to FIG. 7C. More particularly, for instance, the measurement is implemented on the basis of respective measuring items including a cell pitch, an X expand and a Y expand or the like to obtain a measured value. Such a measured value is implemented for all of the minimal units (cells) forming the two-dimensional code Q and a related average value is regarded to be an evaluation value. For instance, the evaluation value is expressed such that the evaluation value of the cell pitch is 0.5; the evaluation value of the X expand is 0.33; and the evaluation value of the Y expand is 0.13.

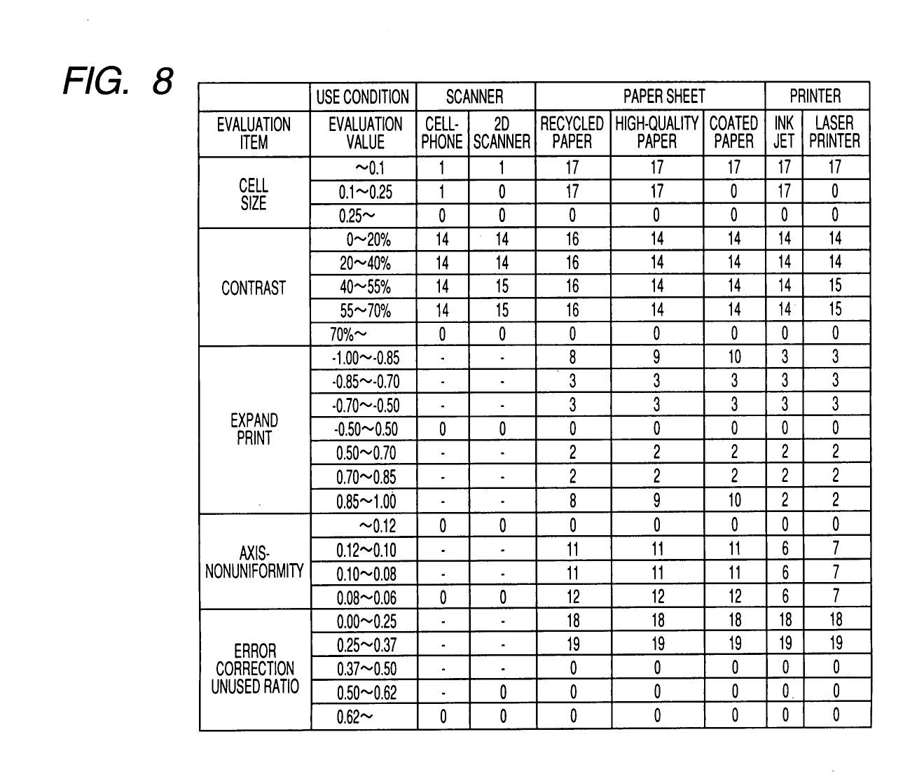

In consecutive step S111, evaluation value converting operation is executed. This operation represents an operation to convert an improving point compliant to the evaluation value calculated in step S109. In particular, for instance, an evaluated value conversion table, shown in FIG. 8, is employed. The evaluated value conversion table is preliminarily stored in a memory 35 and the control circuit 40 retrieves the evaluated value conversion table from the memory 35 for converting an evaluation and improving point on the basis of numbers (0 to 19) indicated on the table.

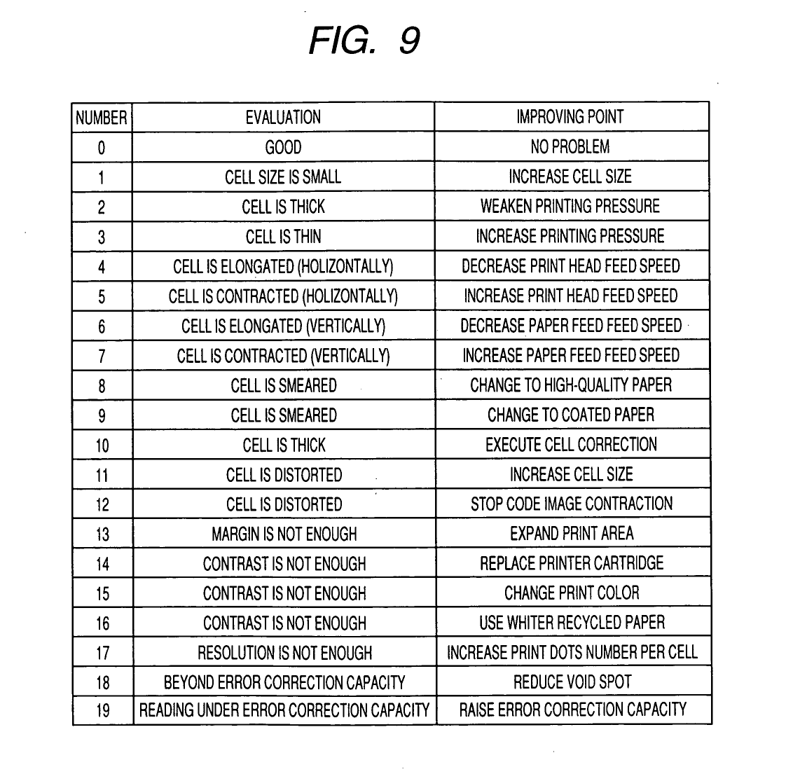

For instance, “USAGE ENVIRONMENT”, “SCANNER”, “PAPER” and “PRINTER” are correlated with the evaluation items such as “CELL SIZE”, “CONTRAST”, “EXPAND PRINT”, “AXIS-NONUNIFORMITY” and “ERROR CORRECTION UNUSED RATIO”, respectively. The cell pitch represents a distance between the relevant cells and corresponds to “CELL SIZE” intact. Moreover, the X expand and Y expand correspond to “EXPAND PRINT”, respectively. Therefore, for instance, in a case where the cell pitch has an evaluation value of 0.5, reference is made to 0.5 for the evaluation value of the cell size. Then, in a case where the cell pitch has the evaluation value of 0.5, this belongs to a range of “0.25˜” (beyond a value of 0.25). Therefore, if the scanner (optical information readout device includes a cell-phone, a binary “0” is present and if the scanner includes a two-dimensional code scanner (2D scanner), the binary “0” is present with the binary “0” representing the number for the respective evaluations and improving points. In addition, the contents of the numbers (0 to 19) for the respective evaluations and improving points are shown in FIG. 9. For instance, the presence of the number with binary “0” represents an evaluation with “Good” and the improving point results in a consequence of “No Problem”.

Further, the X expand of 0.38 and the Y expand of 0.13 correspond to the evaluation item “EXPAND PRINT”. Therefore, for instance, the evaluation value of the expand print, corresponding to the X expand of 0.33, belongs to a range of −0.50˜+0.50 (greater than −0.50 and less than +0.50) and, thus, the number of the evaluation and the improving point corresponds to “0”. Likewise, the evaluation value of the expand print, corresponding to the Y expand of 0.13, belongs to a range of −0.50˜+0.50 (greater than −0.50 and less than +0.50) and, thus, the number of the evaluation and the improving point corresponds to “0”. Accordingly, as shown in FIG. 9, this results in an evaluation with “GOOD” with the improving point resulting in a consequence of “NO PROBLEM”.

Thus, an evaluation value converting operation is executed in step S111 and the number of related evaluation and improving point is obtained, upon which the evaluation result and improving point display operation is executed in subsequent step S113 to provide a display of a message belonging to such number on the liquid crystal display unit 46.

As set forth above, with the two-dimensional code verifier 10 of the present embodiment, the light-receiving sensor 23 picks up an image of the two-dimensional code Q recorded on the reading object R. Then, the control circuit 40 and the memory 35 measures a recorded state of the two-dimensional code Q, picked up by the light-receiving sensor 23, in terms of given evaluation items (including a cell size, a contrast, an expand print, an axis nonuniformity and an error correction and unused ratio), thereby outputting a related measured value. The control circuit 40 and the memory 35 make comparison between the measured value, obtained by the control circuit 40 and the memory 35, and the given reference value (that is, the evaluation value shown in FIG. 8), thereby outputting a comparison result. Subsequently, the control circuit 40, the memory 35 and the liquid crystal display unit 46 executes conversion of the comparison result into a related improving point, and outputs it.

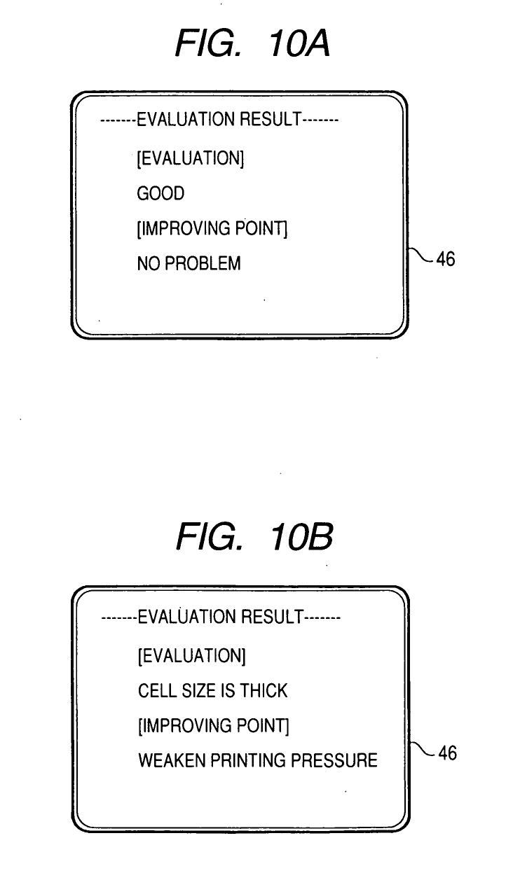

In a case where the recorded state of the two-dimensional code Q, picked up by the light-receiving sensor 23, is improper, the liquid crystal display unit 46 provides a display of a concrete improving point in correspondence to the relevant comparison result on the basis of the comparison result compared to a given reference value (see FIG. 10). It becomes possible to get which part of the recorded two-dimensional code is to be corrected or which point is to be improved. Accordingly, since the record state of the two-dimensional code Q can be properly corrected without asking advice from an expert, a proper two-dimensional code Q can be recorded in a short time at low cost.

In addition, the use condition inputting operation (S101), shown in FIG. 5, may be executed by inputting a record condition of a two-dimensional code Q (optical information) of, for instance, a paper sheet (display medium, record medium, etc.). This makes it possible to convert and output an improving point on the basis of the record condition of the two-dimensional code Q (optical information). Thus, the improving point can be output according to conditions including, for instance, display media (such as, for instance, a quality of a paper sheet (such as a recycled paper, a high-quality paper, coated paper, etc.), on which the two-dimensional code Q is recorded (printed), and a type of equipment (such as an ink jet printer and a laser printer) for recording (printing). Accordingly, a proper improving point can be obtained on the basis of such a record condition without asking advice from the expert or the like, making it possible to record proper optical information in a further shortened time at low cost.

Further, a type of code such as, for instance, a bar code, a two-dimensional code, etc., may be input as a type of optical information in the use condition inputting operation (S101) shown in FIG. 5. This allows the improving point to be converted and output on the basis of the type of optical information and, thus, the improving point can be output in accordance with a difference between the bar code and the two-dimensional code or another difference in size (dimension) or the like. Consequently, even in such a case, a proper improving point can be obtained on the basis of the type of optical information without asking advice from an expert, making it possible to record proper optical information in a further shortened time at low cost.

Moreover, while with the present embodiment, the numbers of the evaluations and improving points associated with the respective evaluation items are set on the evaluated value conversion table as the record conditions of the two-dimensional code Q, as shown in FIG. 8, according to a kind of the paper sheet as record medium, such as “RECYCLED PAPER”, “HIGH-QUALLITY PAPER” and “COATED PAPER”, and a type of a scanner as an optical information readout apparatus, such as “CELL-PHONE” or “2D SCANNER”, a difference in types (such as, for instance, a bar code and a two-dimensional code) of optical information may be additionally included. This makes it possible to convert and output an improving point on the basis of the type of optical information such as the bar code and the two-dimensional code. Therefore, a proper improving point can be obtained on the basis of the type of optical information without asking advice from an expert. This provides a capability of recording proper optical information in a further shortened time at low cost. Moreover, the type of optical information may also include, in addition to the difference in the kind of the bar code and the two-dimensional code, sizes (dimensions) of the bar code and the two-dimensional code.

Further, while with the present embodiment, the LED 43 is turned on and off, and the light emission intensity and the emission color are set according to a given condition, the LED 43 may be turned on and off, and the light emission intensity and the emission color of the LED43 may be set on the basis of conditions in accordance with a type of an optical information readout apparatus such as, for instance, a bar code reader or the like. This enables an evaluation to be made under an environment close to a device condition of the actually used bar code reader or the like. This results in a capability of getting an improving pointsuited to further actual usage environment, making it possible to record proper optical information in a further shortened time at low cost.

Although the present embodiment has such a structure in which the illumination light sources 21 are provided to irradiate the illumination light beams Lf onto the two-dimensional code Q, if the two-dimensional code Q is read out upon irradiating external light beams such as a sunlight or the like, the above-described verifications can be performed without use of the illumination light sources 21.

Furthermore, with the present embodiment set forth above, while the evaluation results and the improving point are displayed on the liquid crystal display unit 46 as Japanese characters, semantic contents of evaluation results and improving point may be output in sound on a beep sound or a quasi sound via an acoustic device such as a buzzer 44 or the like.

In addition, while the present embodiment has been described above with reference a case wherein the two-dimensional code is exemplified as optical information, the present invention is not limited to such a case and may have application to verification of, for instance, so-called bar codes (one-dimensional codes such as EAN/UPC, an interleaved 2 of 5, a coder bar, a code 39/128, a standard 2 of 5, an RSS, etc.,) provided that these bar codes act as optical information. In addition, while the present embodiment has been discussed above particularly with reference to the QR code of a matrix code (matrix symbol) system as optical information, the present invention is not limited to such a case and may have application to a verification of another matrix code system (a data matrix, a maxi code, a micro QR code, etc.,) and a multi-row code (multi-row symbol) system (a PDF417, a micro PDF417, an RSS composite, etc.).

What is claimed is:

1. An optical information verification apparatus comprising:
an image pickup section picking up an image of optical information recorded on a display medium;
a measuring section measuring a record state of the optical information picked up by the image pickup section in terms of a given evaluation item and outputting a measured value of the record state;
a comparing section comparing the measured value output from the measuring section with a given reference value, and outputting a comparison result; and
an improving point outputting section converting the comparison result output from the comparing section into an improving point associated with the comparison result, and outputting the improving point.

2. The optical information verification apparatus according to claim 1, further comprising a record condition inputting section for inputting a record condition of the optical information affecting the record condition of the optical information,
wherein the improving point outputting section converts the comparison result into the improving point depending on the record condition input by the record condition inputting section.

3. The optical information verification apparatus according to claim 1, further comprising a readout condition inputting section for inputting a readout condition of the optical information affecting the record condition of the optical information,
wherein the improving point outputting section converts the comparison result into the improving point depending on the readout condition input by the readout condition inputting section.

4. The optical information verification apparatus according to claim 1, further comprising a type information inputting section for inputting a type of the optical information affecting the record condition of the optical information,
wherein the improving point outputting section converts the comparison result into the improving point depending on the type input by the type information inputting section.

5. The optical information verification apparatus according to claim 1, further comprising:
an inputting section for inputting at least one of a record condition of the optical information affecting the record condition of the optical information, a readout condition of the optical information affecting the record condition of the optical information, and a type of the optical information affecting the record condition of the optical information; and
an improving point conversion table operative to retrieve therefrom the improving point depending on at least one of the record condition, the readout condition and the type input by the inputting section, and the comparison result output from the comparing section.

6. The optical information verification apparatus according to claim 1, wherein the optical information verification apparatus is portable, and further comprises:
a readout port to which a reflected light beam reflected from the optical information can be incident; and
a guide member mounted to the readout port so as to extend outwardly to enable a distance between the readout port and the optical information to be kept at a predetermined value.

7. The optical information verification apparatus according to any one of claim 1, wherein the optical information verification apparatus is portable and further comprises:
an illuminating section operative to irradiate an illumination light beam onto the optical information;
a readout port operative to take in a reflected light beam resulting from the illumination light beam reflected by the optical information; and
a light interception member mounted to an opening periphery of the readout port so as to allow the illumination light beam and the reflected light beam to pass therethrough, while blocking external light other than the illumination light beam and the reflected light beam.

8. The optical information verification apparatus according to claim 7, wherein the illuminating section is configured to irradiate an illumination light beam having substantially the same emission property as an illumination light beam which an optical information readout apparatus irradiates onto the optical information to read out the optical information.

9. The optical information verification apparatus according to claim 8, wherein the illumination light beam has three primary color components or a white color component, and emission intensity and conditions to turn on and off are independently set for each color component.

10. The optical information verification apparatus according to claim 1, wherein the improving point outputting section is operative to output the improving point through at least one of display means capable of displaying at least one of character information, mark information and figure information, and an outputting means capable of outputting at least one of a voice and a sound.
